(19) United States
(12) Patent Application Publication
(10) Pub. No.: US 2026/0300284 A1
(43) Pub. Date: Oct. 1, 2026

(54) Hierarchical Learning for Information Retrieval and Exploration

(71) Applicant: Sathya Narayan Reddy, Boston, MA (US)

(72) Inventor: Sathya Narayan Reddy, Boston, MA (US)

(21) Appl. No.: 19/577,822

(22) Filed: Mar. 25, 2026

Related U.S. Application Data
(60) Provisional application No. 63/777,759, filed on Mar. 26, 2025.

(51) Int. Cl. G06F 16/2452; G06F 16/26

(52) U.S. Cl. CPC G06F 16/24522; G06F 16/26

(57) ABSTRACT

A computer-implemented method for information retrieval is disclosed in which a structured relational model is learned from domain-associated data. The learned model defines admissible multi-entity interaction configurations, including unary, binary, and higher-order n-ary configurations, subject to domain constraints. A natural language query is received and transformed into a structured query representation comprising at least one fully or partially specified multi-entity relational configuration. The structured query representation may include unspecified relational roles. The system identifies configuration regions within the structured relational model that are compatible with the structured query representation and retrieves information from an information store based on the identified configuration regions. In certain implementations, the structured relational model includes relational sections organized in a hierarchical refinement structure, supports algebraic operations over configuration regions, and enforces consistency across overlapping multi-entity configurations. Retrieval is performed with respect to admissible relational configurations rather than solely matching stored relational instances.

### CROSS-REFERENCE TO RELATED APPLICATION(S)

This application claims the benefit of U.S. Provisional Application No. 63/777,759 filed Mar. 26, 2025, the contents of which are included herein by reference.

### TECHNICAL FIELD

This disclosure relates to information retrieval, and in particular to information retrieval using learned relationships.

### BACKGROUND

Modern information retrieval systems increasingly accept natural language input while operating over structured data stores. Historically, such systems relied on classical natural language processing techniques to extract structured meaning from text. These techniques included tokenization, part-of-speech tagging, syntactic parsing, semantic role labeling, and named entity recognition (NER). Extracted entities and relations were then mapped into structured representations compatible with relational databases or knowledge graphs.

Knowledge graphs became a common architecture for organizing structured information. In such systems, entities are represented as nodes and relationships as labeled edges. While most graph models natively support binary relations, interactions involving three or more participants, referred to as n-ary relations, are typically represented by introducing an intermediate relational node that connects to each participant through role-specific edges. This allows complex events and interactions to be represented within a graph-based framework.

In parallel, ontology-based systems introduced formal mechanisms for specifying class hierarchies, relationship types, and logical constraints. Such systems permit the declaration of domain-specific entity types, role restrictions, cardinality constraints, and subclass relationships. Automated reasoning engines can infer additional facts that logically follow from explicitly represented information and can detect inconsistencies in stored data.

As natural language interfaces became more prevalent, research focused on translating user queries into structured queries over these predefined schemas. Classical semantic parsing techniques mapped questions into graph patterns or structured query languages. More recently, large language models (LLMs) have been used to extract entities and candidate relations from user input, generate structured representations, and even produce graph query expressions. In such systems, LLMs may assist in interpreting user intent and aligning it to the underlying structured schema.

Despite these advances, conventional approaches share a common architectural assumption: the relational schema and its permissible combinations are defined in advance, and natural language input must be interpreted and aligned to that fixed structure. The system retrieves or infers facts that conform to the predefined graph or ontology. Even where n-ary relations are supported, they are treated as stored instances within a graph, and retrieval consists primarily of matching query patterns against those instances.

Moreover, although LLMs are capable of producing fluent and contextually coherent responses, they do not inherently operate over explicitly structured relational schemas or enforce multi-participant constraints across n-ary relationships. Their outputs are generated from learned statistical patterns rather than from explicit manipulation of formally structured configuration spaces. As a result, holistic reasoning over interdependent relational structures, particularly where multiple entities must satisfy jointly defined constraints, is not natively enforced by LLM-based systems without additional external structuring.

Accordingly, existing systems typically implement a pipeline in which: (i) natural language input is parsed or interpreted; (ii) entities and relations are mapped into a predefined relational schema or knowledge graph; and (iii) retrieval and reasoning are performed over stored relational instances. The structured schema itself remains largely static, and the primary object of computation is the set of stored facts rather than the structured space of admissible relational configurations. As a result, users are often presented with flat, ranked outputs that do not expose the underlying relational structure of a domain, making it difficult to explore unfamiliar domains or understand alternative interaction patterns. Additionally, retrieved results are treated as static outputs, limiting the ability to compose, compare, or refine relational information. Further, such systems do not expand their structural reasoning capabilities across queries, and they lack mechanisms for enforcing consistency across overlapping relational contexts, leading to potential inconsistencies or unsupported combinations.

### SUMMARY

The present disclosure introduces a configuration-centric framework for information retrieval that departs from the conventional paradigm of mapping natural language queries into a fixed relational schema populated with stored instances. Traditional systems may treat relational facts, whether represented in databases or knowledge graphs, as the primary objects of storage and retrieval. In contrast, the disclosed approach models and operates over a structured relational configuration space that defines admissible multi-entity interactions within a domain. In this framework, the space of permissible relational combinations becomes the primary object of learning, organization, and retrieval. Conventional retrieval over relational instances often requires repeated multi-way joins, graph traversals, or full scans to evaluate multi-entity constraints, particularly for partially specified n-ary queries with contextual qualifiers. The disclosed system addresses this technical problem by maintaining a sectioned, refinement-consistent representation of admissible configurations and executing query evaluation as compatibility filtering and algebraic transformation over configuration regions using role-keyed indices, constraint indices, and projection link structures.

In contrast to such limitations, the disclosed framework constructs a finite set of relational contexts that collectively represent a domain region associated with a query, enabling structured exploration rather than ranked retrieval. The system represents information as composable configuration regions that support algebraic operations, thereby enabling active construction and transformation of relational information. Through learning, the system induces reusable relational structures that extend its reasoning capabilities across queries. The system further enforces consistency across overlapping relational contexts through compatibility conditions applied across the hierarchical refinement structure, thereby improving reliability of multi-context reasoning.

In one aspect, the disclosed system constructs a span of relational sections representing unary, binary, and higher-order (n-ary) configurations among entities in a domain. These relational sections are not merely collections of edges in a flat graph, but structured configuration regions that capture admissible combinations of entities and their roles subject to domain constraints. The sections are organized within a hierarchical refinement topology in which broader relational contexts progressively refine into more specific multi-entity configurations. This hierarchical organization enables the system to represent interactions at multiple levels of abstraction while preserving structural relationships among them.

In certain implementations, the system learns valid entity assignments and significant relational sections from observed domain-associated data, including structured records and extracted relational instances. Rather than relying solely on a predefined ontology that specifies permissible combinations in advance, the disclosed approach derives and aligns relational sections based on observed patterns and constraint conditions within the data. Learned structures are aligned with the hierarchical refinement topology to ensure that refinements maintain consistency across overlapping relational regions. The resulting configuration space, comprising admissible multi-entity interaction configurations organized hierarchically, serves as the primary object for retrieval and structured exploration.

The system further supports algebraic operations directly over relational configuration regions as first-class structured information units. Such operations are defined over configuration regions within the admissible configuration space and are not dependent on prior retrieval of ranked instances. Such operations may include composition of relational regions, projection from higher-order to lower-order configurations, restriction of configuration regions by additional constraints, comparison of overlapping sections, and set-like operations such as union and difference. These operations are performed over structured configuration regions rather than over individual relational instances, enabling structured manipulation of admissible interaction spaces beyond conventional graph traversal or pattern matching. In some implementations, hierarchical metrics may be computed across the configuration space and attributed to sections and entities in a manner that preserves structural consistency across refinement levels.

In operation, the system receives a natural language query and derives from the query a structured query representation comprising at least one fully or partially specified multi-entity relational configuration. The structured representation may identify certain entities, roles, or relational constraints while leaving other roles unspecified, thereby defining a constrained relational pattern within the configuration space. This structured query representation is not limited to a fixed graph pattern but corresponds to a region within the learned configuration model.

The system identifies, within the learned structured relational model, configuration regions that are compatible with the structured query representation. Compatibility may be determined based on satisfaction of relational roles, constraint conditions, and admissible combinations learned from domain data. Retrieval is then performed with respect to these compatible configuration regions, enabling the system to return information corresponding to admissible multi-entity interactions consistent with the structured query representation.

By modeling and operating over admissible relational configurations as structured regions within a learned relational model, rather than solely matching stored graph patterns derived from a predefined schema, the disclosed approach enables structured retrieval over partially specified multi-entity interactions. This configuration-space framework supports hierarchical, closed-loop exploration of relational combinations and provides structured operational capabilities extending beyond conventional graph-based or ontology-backed information retrieval systems.

In certain implementations, the structured relational model comprises a plurality of relational sections representing unary, binary, and higher-order n-ary interaction configurations that are explicitly organized according to the hierarchical refinement structure. A given relational section may refine another relational section by imposing additional relational roles, entity constraints, or contextual conditions. Overlapping relational sections may share subsets of entities or constraint definitions, and the refinement structure preserves the compatibility of such overlapping regions across different levels of abstraction. This hierarchical organization enables consistent reasoning across local and global relational contexts.

In some embodiments, learning the structured relational model includes identifying statistically significant multi-entity interaction patterns within domain-associated data and distinguishing admissible configurations from inadmissible or unsupported combinations. Domain constraints may include role-specific participation rules, cardinality limitations, compatibility requirements among entities, or other conditions governing permissible multi-entity interactions. The learning process may therefore determine not only observed relational instances but also the boundaries of admissible configuration regions within the domain.

In further implementations, compatibility between the structured query representation and the structured relational model includes enforcing local-to-global consistency across overlapping relational sections. When a partially specified multi-entity configuration is derived from a natural language query, the system may expand the partially specified configuration into one or more admissible completed configurations that satisfy learned constraint conditions. Such expansion may occur within the learned configuration space while preserving consistency across refinement levels.

In certain embodiments, algebraic operations over relational configuration regions enable structured combination and transformation of interaction spaces. For example, composition of configuration regions may generate a combined admissible interaction space from two partially specified relational configurations. Projection operations may derive lower-order configuration regions from higher-order configurations while preserving admissibility constraints. Restriction operations may narrow configuration regions based on additional constraints, and comparison operations may identify commonalities or differences between overlapping relational regions. These operations permit manipulation of structured interaction spaces in a manner that extends beyond conventional graph traversal or static query matching.

In some implementations, the structured relational model defines, for an entity, a neighborhood comprising all admissible multi-entity configurations in which the entity participates across refinement levels. Retrieval may be performed with respect to such neighborhoods, enabling entity-centric exploration of admissible interaction spaces. Neighborhood-based retrieval may support aggregation, comparison, or subtraction of configuration regions associated with different entities or groups of entities.

In additional embodiments, hierarchical metrics may be computed over the structured relational model and attributed to relational sections or entities. Such metrics may reflect structural novelty, interaction complexity, magnitude of participation, or other measures derived from the distribution of admissible configurations across refinement levels. Metric attribution may preserve consistency across overlapping relational regions, enabling interpretable navigation and prioritization within the configuration space.

In certain implementations, the system further constructs, from a structured query representation, a relational topology defining a context signature within the configuration space, identifies anchor elements that define coordinate systems for exploration, selects differentiating relational dimensions, and generates a finite differentiating cover of configuration regions organized into a hierarchical structured response. The structured response provides a navigable representation of admissible multi-entity interaction configurations that is consistent with domain constraints and supports iterative refinement and exploration.

Unlike systems that return a ranked subset of results based on frequency or scoring, the disclosed system constructs a finite differentiating cover comprising a plurality of relational contexts that collectively cover a query-specific region of the admissible configuration space. Each context corresponds to a distinct configuration region defined over relational roles and constraints, such that the cover provides a structured decomposition of the domain region associated with the query rather than a ranked list of individual results. The contexts are selected to jointly achieve coverage of admissible configurations while preserving differentiation of entity participation across relational roles and interaction patterns.

Accordingly, the disclosed framework supports structured learning, manipulation, and retrieval over admissible multi-entity interaction configurations organized within a hierarchical refinement structure. By treating configuration regions as first-class objects of modeling and computation, and by enabling algebraic operations and neighborhood-based exploration over such regions, the system provides structured information retrieval capabilities that extend beyond conventional instance-level graph matching approaches.

Other features and advantages of the invention are apparent from the following description, and from the claims.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is system block diagram;

FIG. 2 is a schematic diagram illustrating formation of a configuration region from a structured query representation evaluated against a relational section of a structured relational model;

FIG. 3 is a schematic diagram illustrating a hierarchical refinement structure and projection relationships among relational sections of the structured relational model; and

FIG. 4 is a schematic diagram illustrating construction and expansion of a neighborhood of a domain element across relational sections of the structured relational model.

### DETAILED DESCRIPTION

### 1. Overview

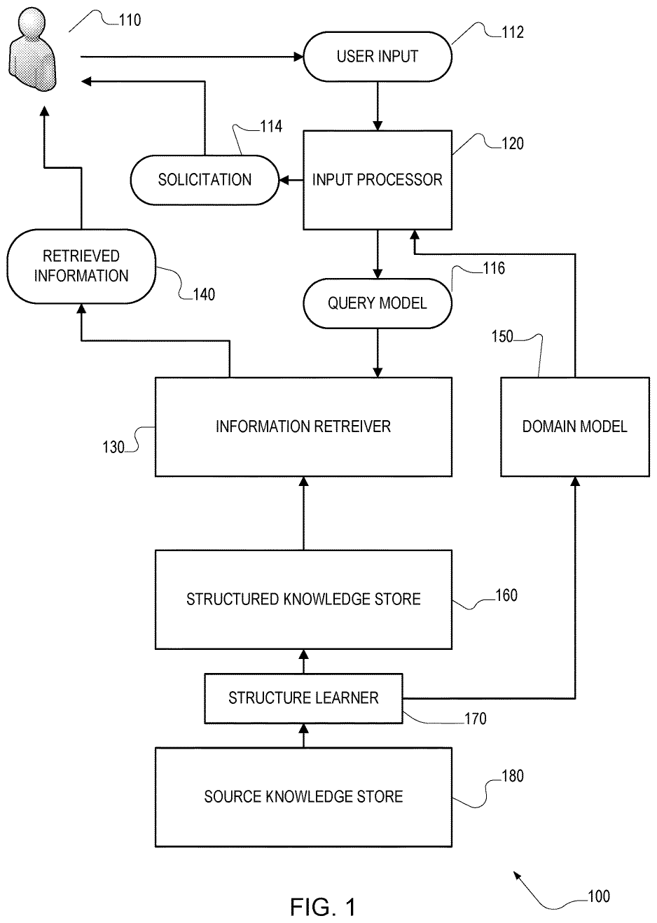

Referring to FIG. 1, a computer-implemented information retrieval system 100 is illustrated in FIG. 1. The system is configured to receive input 112 from a user 110 and to return responsive information derived from a corpus of source materials. The user input 112 may be expressed in natural language, structured data form, or a combination thereof. An input processor 120 interprets the user input and generates a query model 116, which is a structured representation of the information sought by the user. The query model is expressed in terms of entities, relationships, attributes, and constraints defined by a domain model 150.

The domain model 150 characterizes the structural organization of information within the system, including admissible types of entities and permissible relationships among them. The domain model thereby defines a structured representation framework within which both stored information and user queries are interpreted. The input processor 120 utilizes the domain model 150 to resolve ambiguities, enforce structural consistency, and, where appropriate, generate solicitations 114 that are presented to the user 110 to obtain clarification or additional details. Through this process, the query model 116 is refined into a structured form that conforms to the domain model.

The system further includes a structured knowledge store 160 that contains instances of entities and relationships organized in accordance with the domain model 150. These structured instances are derived from a source knowledge store 180, which may include unstructured or semi-structured materials such as documents. A structure learner 170 processes content from the source knowledge store 180 to identify entities, relationships, and attributes consistent with the domain model 150, and to populate the structured knowledge store 160 with corresponding structured representations.

Once the query model 116 is formed, an information retriever 130 operates over the structured knowledge store 160 to identify stored instances that satisfy the entities, relationships, and constraints specified in the query model. The retriever thereby identifies one or more configurations of related entities that correspond to the user's request. Retrieved information 140 may be returned in structured form or may be transformed into a presentation format suitable for the user, including natural language summaries, visualizations, or other renderings.

In this manner, the system operates over a structured representation of domain knowledge in which both stored information and user queries are expressed within a common framework. Query processing consists of constructing a structured representation of the user's request and identifying corresponding structured configurations within the stored knowledge, thereby enabling retrieval that is guided by domain-specific structural constraints rather than by keyword matching alone.

Below is a full rewrite of the section, incorporating your original substance and integrating explicit ties to FIG. 1 components (domain model 150, structure learner 170, structured knowledge store 160, input processor 120, information retriever 130, and retrieved information 140). No concepts have been removed; the architecture is now explicitly grounded.

Before describing runtime system operation with reference to FIG. 1, the arrangement of information in computer memory and the operations that may be performed over that information are described in detail.

### 2. Arrangement of Information

Information maintained by the system, including information stored in the structured knowledge store 160 and information represented as retrieved information 140, is organized according to a domain model 150. The domain model 150 is maintained in computer memory and provides a structured specification of the domain in which the system operates. The domain model 150 is used by the structure learner 170 when transforming information from the source knowledge store 180 into structured form, by the input processor 120 when interpreting user input 112 to generate a query model 116, and by the information retriever 130 when evaluating stored information to produce retrieved information 140.

The domain model 150 defines (i) domain elements belonging to domain sets, (ii) relations among those domain elements, including unary, binary, and n-ary relations, (iii) relational sections defined over those relations, (iv) domain constraints governing admissibility of assignments within those sections, and (v) a hierarchical refinement structure organizing the sections. Collectively, these structures define an admissible configuration space within which both stored information and user queries are interpreted.

### Domain Elements

A domain element is a discrete, uniquely identifiable and addressable unit maintained in computer memory and belonging to one or more domain sets defined by the domain model 150. Domain elements may correspond to entities, attributes, values, events, roles, classifications, or other identifiable items within a domain.

Each domain element has a unique identifier and may include associated metadata. The structural significance of a domain element derives from its participation in one or more relations and its inclusion in admissible configurations within one or more sections. Domain elements are stored as part of the structured knowledge store 160. The structure learner 170 identifies candidate domain elements from the source knowledge store 180 and assigns them to domain sets defined by the domain model 150. The input processor 120 refers to these domain sets when interpreting user input 112 to ensure that referenced items correspond to valid domain elements.

For example, in a movie domain, a specific movie, a particular actor, or a named director may each constitute a domain element. In a startup-investment domain, a startup, an investor, a funding round, or a funding event may each constitute a domain element. Domain elements serve as atomic referents over which relations are defined, constraints are evaluated, sections are formed, and configurations are constructed.

### Relations

A relation is a formally specified association defined over one or more domain sets. Each relation has a defined arity and a relational signature identifying the participating domain sets and relational roles or positions by which domain elements participate.

A unary relation associates a property, classification, or attribute with elements of a single domain set.

A binary relation associates ordered or role-differentiated pairs of domain elements drawn from two domain sets.

An n-ary relation associates tuples of domain elements drawn from n domain sets, capturing joint participation within a single relational occurrence. N-ary relations are maintained as first-class structures so that joint participation is preserved explicitly rather than decomposed into independent pairwise links.

Relation instances are represented in the structured knowledge store 160 as assignments of specific domain elements to the roles defined by the relational signature. The structure learner 170 generates such relation instances from the source knowledge store 180 in accordance with the domain model 150. The information retriever 130 evaluates relation instances when determining whether particular configurations satisfy the structured conditions expressed in a query model 116.

### Domain Constraints

Relations and sections are subject to domain constraints defined by the domain model 150. Domain constraints restrict admissible assignments of domain elements to relational roles and may include type restrictions, logical conditions, equality or inequality conditions, cardinality limitations, compatibility requirements among roles, participation rules, and other structural or semantic conditions.

Domain constraints ensure that only assignments satisfying defined structural and logical conditions are considered admissible. Constraints may apply at the level of individual relations, at the level of sections defined over one or more relations, or across multiple overlapping sections within the hierarchical refinement structure. In some implementations, constraints enforce consistency among shared projections of higher-order configurations into lower-order sections.

In certain implementations, domain constraints further include cross-sectional compatibility constraints defined over overlapping relational sections. Where two or more relational sections share one or more domain elements or projected role assignments, admissibility of configurations is conditioned not only on satisfaction of local section-level constraints, but also on consistency of assignments across such overlapping sections.

In some embodiments, this cross-sectional compatibility is enforced by defining, for overlapping relational sections, corresponding restriction mappings that relate assignments in a higher-order or neighboring section to assignments in a shared lower-order or intersecting section. A collection of assignments across multiple sections is considered jointly admissible if the assignments agree under such restriction mappings on all shared projections. In this manner, admissible configurations satisfy a local-to-global consistency condition across overlapping relational regions.

In certain implementations, the restriction mappings are configured such that compositions of mappings along different relational paths yield consistent results. For example, where a first relational section maps to a second section and the second section maps to a third section, and where an alternative mapping path exists between the first and third sections, admissibility may require that the composed mappings along the different paths produce consistent assignments. Failure to satisfy such consistency conditions indicates incompatibility among the corresponding configurations.

This structure may be viewed as imposing a compatibility framework over a collection of overlapping relational sections in which locally valid assignments must agree on overlaps to form globally valid configurations. In some implementations, this compatibility framework corresponds to a sheaf-like structure defined over the relational sections, in which admissible configurations correspond to compatible families of local assignments across overlapping regions.

### Sections

A section is a structured unit defined over one or more relations within a relational topology. A section corresponds to a particular relational signature together with associated domain constraints and defines a space within which assignments of domain elements to relational roles are evaluated for admissibility.

Sections may correspond to unary levels involving a single domain set, binary levels involving pairwise relations, or higher-order levels involving n-ary relations. Each section is addressable in memory and is configured to store, reference, index, or otherwise represent configurations that are valid with respect to its relational signature and associated domain constraints. Such representations may be maintained within the structured knowledge store 160.

Sections are not merely collections of stored relation instances. Rather, each section defines an admissible region within a configuration space corresponding to its relational signature and constraint structure. The input processor 120 may generate a query model 116 corresponding to one or more sections, relational roles, and constraints defined by the domain model 150. The information retriever 130 evaluates configurations within the corresponding sections to identify admissible configurations responsive to the user's request.

### Hierarchical Refinement Structure

Sections are organized in a hierarchical refinement structure defined by a partial order. A section may refine another section by imposing additional relational roles, imposing additional domain constraints, or both, while preserving compatibility with projections of configurations from the refining section into the refined section.

Refinement corresponds to monotonic strengthening of structural or constraint conditions within the configuration space. If a first section refines a second section, each valid configuration in the first section induces, through projection onto a subset of roles, a valid configuration in the second section. Refinement relationships preserve admissibility and projection consistency across levels of abstraction and across overlapping relational regions.

### Configurations

A configuration is a specific assignment of domain elements to the roles of one or more relations within a section. A configuration represents a concrete multi-entity interaction occurrence under the relational signature of the section.

A configuration is valid with respect to a section if the assigned domain elements satisfy all domain constraints associated with the relevant relations and the section. Configurations that violate applicable constraints are excluded from admissible regions of the corresponding section.

Configurations are hierarchical within the hierarchical refinement structure. A valid higher-order configuration induces valid lower-order configurations in corresponding sections through projection. Hierarchical validity requires consistency across these levels.

### Configuration Space and Admissibility

The set of all valid configurations across all sections defines a configuration space for the domain. The configuration space comprises those assignments of domain elements to relational roles that satisfy applicable domain constraints and hierarchical consistency requirements. The configuration space may be viewed as a constrained subset of the space of all logically possible assignments under the defined relational signatures.

The configuration space defined by the domain model 150 serves as the structural universe within which both stored information and user queries are interpreted. The query model 116 generated by the input processor 120 specifies one or more regions within this configuration space by identifying domain elements, relational roles, and constraints. Retrieval performed by the information retriever 130 consists of identifying admissible configurations within the structured knowledge store 160 that fall within the region specified by the query model.

### Neighborhoods

A neighborhood of a domain element is the collection of valid configurations across sections in which the domain element appears. In a base scope, the neighborhood includes all sections for which the domain element participates in at least one valid configuration.

Neighborhood scope may be parameterized by relational step distance. A zero-step neighborhood includes configurations in which the domain element directly appears. A one-step neighborhood additionally includes configurations associated with other domain elements that co-occur with the element in valid configurations. Multi-step neighborhoods may be constructed recursively, subject to defined limits and redundancy control, while preserving admissibility and relational integrity.

The information retriever 130 may construct or traverse neighborhoods when assembling retrieved information 140. Retrieved information 140 may include structured representations of one or more neighborhoods centered on domain elements specified directly or indirectly in the query model 116. Because neighborhoods are defined over admissible configurations within sections, retrieved information preserves hierarchical refinement consistency and domain admissibility as defined by the domain model 150.

Accordingly, the domain model 150 defines the structural rules governing admissible configurations; the structure learner 170 populates the structured knowledge store 160 with domain elements and relation instances consistent with those rules; the input processor 120 interprets user input 112 by generating a query model 116 expressed within the same structural framework; and the information retriever 130 identifies admissible configurations and neighborhoods within the structured knowledge store 160 that satisfy the structured conditions of the query model. Retrieved information 140 is generated from such admissible configurations and may be presented in structured form or transformed into a presentation format for the user 110.

### 3. Operations on Information

The structured relational model defined by the domain model 150 and implemented within the structured knowledge store 160 supports a defined set of operations over domain elements, relations, sections, configurations, configuration regions, and neighborhoods. These operations are performed by one or more system components shown in FIG. 1, including the input processor 120 and the information retriever 130, and act directly over admissible multi-entity interaction configurations organized within the hierarchical refinement structure. The operations preserve domain constraint validity and hierarchical consistency and enable structured query evaluation, retrieval, comparison, refinement, aggregation, validation, metric attribution, and exploration within the admissible configuration space.

### Configuration Regions

A configuration region is a structured subset of valid configurations within one or more sections, characterized by specified relational role assignments, domain constraint predicates, or structural conditions defined with respect to the domain model 150. A configuration region may arise from evaluation of a query model 116 generated by the input processor 120, from algebraic combination of previously derived regions, from restriction by additional domain constraints, or from neighborhood construction.

A configuration region is not merely a collection of arbitrary tuples, but a subset of admissible configurations defined with respect to a relational signature, applicable domain constraints, and hierarchical context within the refinement structure. Configuration regions preserve sectional identity and maintain linkage to the hierarchical refinement structure. Configuration regions constitute principal units over which compatibility determination, algebraic manipulation, and retrieval are performed by the information retriever 130.

A partially specified multi-entity relational configuration defines a configuration region consisting of all admissible completions of that partial specification within the structured relational model. In this sense, partially specified configurations operate as region-defining operators over the configuration space defined by the domain model 150. The resulting region may be represented, indexed, or otherwise maintained within the structured knowledge store 160 for evaluation.

### Differentiating Covers of Configuration Regions

A differentiating cover comprises a finite collection of configuration regions, each corresponding to a distinct relational context, such that the collection jointly covers a query-specific region of the admissible configuration space. The configuration regions are further selected such that patterns of entity participation across relational roles differ among the regions, thereby enabling differentiation of entities and their roles within the query-specific portion of the configuration space. Each configuration region represents a structured context defined over a relational signature, role assignments, and constraint predicates, rather than an individual retrieved instance. The regions are selected to collectively span the relevant domain subspace induced by the structured query representation while maintaining differentiation among entity participation patterns, relational roles, or constraint regimes.

Each configuration region in the cover is defined with respect to one or more selected relational dimensions and associated domain constraints. The regions are selected such that they are jointly sufficient to represent the variability of admissible configurations within the query-specific subspace while minimizing redundancy among regions.

The differentiating cover is constructed based on criteria including informativeness, diversity of relational structure, differentiation of entity participation patterns across regions, and coverage of admissible configurations. In some implementations, selection of regions within the cover is performed using a reward-driven process that evaluates candidate regions according to multi-objective criteria reflecting structural significance and explanatory value.

Unlike retrieval approaches that return a fixed number of individual instances based on ranking or frequency, the differentiating cover provides a structurally complete representation of the relevant configuration space in terms of relational contexts. Each region in the cover may serve as a basis for further exploration, refinement, or comparison within the structured relational model.

In certain implementations, construction of the differentiating cover is performed under guidance of the coupled relation-question-source (R-Q-S) structures. Candidate configuration regions are evaluated not only for structural distinctiveness within the relational model, but also for responsiveness to interrogative forms in the question structure and evidentiary support within the source structure. In this manner, each region included in the differentiating cover corresponds to a relational context that (i) captures a distinct pattern of admissible multi-entity interaction, (ii) answers a class of queries associated with the structured query representation, and (iii) is grounded in supporting source evidence. The resulting differentiating cover therefore constitutes a set of context units that are jointly structurally complete, interrogatively meaningful, and evidentially supported, thereby enabling construction of a structured response that reflects both the relational configuration space and the informational needs expressed by the query.

### Compatibility Determination

Compatibility determination, as performed by the information retriever 130, evaluates whether candidate configurations within the structured knowledge store 160 satisfy the structural and constraint conditions expressed in a query model 116 or other configuration region. Compatibility is defined as satisfaction of all relational role assignments and domain constraint predicates specified in the structured representation, together with satisfaction of all section-level domain constraints and hierarchical consistency requirements applicable to the candidate configurations. This compatibility determination further operates as a verification mechanism that ensures consistency across overlapping relational contexts. By enforcing agreement of assignments across shared projections and across multiple relational paths, the system prevents inclusion of configurations that are locally admissible but globally inconsistent, thereby improving reliability of multi-context reasoning.

Compatibility determination may include verifying that assigned domain elements satisfy type and role-specific participation rules; evaluating domain constraint predicates such as numerical thresholds, categorical restrictions, temporal conditions, or logical relationships; ensuring that candidate configurations are valid within their respective sections; enforcing local-to-global consistency across overlapping sections; and verifying that projections of candidate configurations remain valid in lower-order sections within the hierarchical refinement structure.

A configuration region identified as compatible therefore consists of admissible multi-entity interaction configurations that lie within the admissible configuration space and satisfy all imposed structural and constraint conditions. Such regions may form part of retrieved information 140.

In certain implementations, compatibility determination further includes enforcing cross-sectional consistency conditions across overlapping relational sections using restriction mappings defined between sections. Candidate configurations identified within different sections are evaluated for mutual compatibility by projecting the configurations onto shared relational roles and verifying agreement of projected assignments.

In some embodiments, compatibility enforcement includes verifying that alternative projection paths between related sections yield consistent results. For example, where a candidate configuration may be projected from a higher-order section to a lower-order section through multiple sequences of intermediate sections, the resulting projected assignments are required to agree. Inconsistency among such projections indicates a violation of structural compatibility and results in exclusion or segregation of the corresponding configuration.

Such multi-path consistency evaluation enforces a local-to-global coherence condition over the structured relational model and prevents inclusion of configurations that are locally admissible within individual sections but globally incompatible across overlapping relational regions.

### Set-Like Operations on Configuration Regions and Neighborhoods

Configuration regions and neighborhoods are composable units of structured information maintained in accordance with the domain model 150 and represented within the structured knowledge store 160. These units support algebraic set-like operations defined over admissible configurations and executed by the information retriever 130.

In certain implementations, configuration regions constitute primary computational objects of the system, and algebraic operations over such regions are performed independently of any ranked retrieval of individual instances. Rather than retrieving a set of instances and subsequently transforming them, the system directly constructs, transforms, and evaluates configuration regions as structured units within the admissible configuration space.

A union operation over two configuration regions produces a configuration region comprising all admissible configurations that appear in either operand region. An intersection operation produces a configuration region comprising only those admissible configurations common to both operand regions. A different operation removes configurations in one configuration region from another, yielding a residual region constrained to admissible configurations within the structured relational model.

When configuration regions are combined, the resulting region is evaluated to ensure that all configurations remain admissible under applicable domain constraints and consistent within the hierarchical refinement structure. Resulting configuration regions may be returned as retrieved information 140 or used as intermediate regions for further evaluation.

### Restriction Operations

Restriction operations apply additional domain constraint predicates to a configuration region, thereby narrowing the region within the admissible configuration space. For example, a configuration region corresponding to admissible funding-event configurations may be restricted by a numerical threshold on investment amount. Restriction preserves the relational signature of the underlying section while reducing the subset of admissible configurations.

Restriction operations may be applied iteratively in response to successive structured query inputs processed by the input processor 120. The information retriever 130 evaluates each restricted region within the structured knowledge store 160 to maintain admissibility and hierarchical consistency.

### Projection Operations

Projection operations derive lower-order configuration regions from higher-order configuration regions by eliminating one or more relational roles while preserving assignments to retained roles. Projection is defined with respect to the hierarchical refinement structure and relational signatures defined by the domain model 150.

Projection preserves admissibility in that a projected configuration is valid in a lower-order section if and only if the originating higher-order configuration satisfies all domain constraints applicable to the retained roles. Projection does not introduce new configurations outside the admissible configuration space; rather, it produces lower-order views of existing admissible configurations. Projection operations enable structured traversal between levels of abstraction within the hierarchical refinement structure and may be used by the information retriever 130 to support drill-down and drill-up exploration in retrieved information 140.

### Composition Operations

Composition operations combine compatible partially specified configuration regions into a unified configuration region. Composition aligns shared relational roles and enforces domain constraint consistency across the combined region. Composition may be invoked in response to structured query representations generated by the input processor 120.

For example, a first configuration region may correspond to admissible configurations satisfying one set of role assignments, and a second configuration region may correspond to configurations satisfying another set of role assignments. Composition produces a configuration region consisting of admissible configurations satisfying both sets of assignments and associated domain constraint predicates, subject to hierarchical consistency. The information retriever 130 evaluates composed regions within the structured knowledge store 160.

### Hierarchical Navigation Operations

Because sections are organized within a hierarchical refinement structure defined by the domain model 150, navigation operations permit traversal across refinement levels while preserving admissibility.

A drill-down operation moves from a higher-order section to one or more lower-order sections derived by projection. A drill-up operation moves from a lower-order section to a higher-order section that refines it. Lateral traversal permits movement between sections at the same refinement level that share structural characteristics or overlapping domain elements. These navigation operations alter the granularity of structural examination without altering the underlying admissibility of configurations and may be used by the information retriever 130 when constructing retrieved information 140.

### Neighborhood Construction and Expansion

Neighborhood construction is an operation over the structured relational model that aggregates all admissible configurations in which a specified domain element participates. Neighborhood construction may be initiated in response to a query model 116 and performed by the information retriever 130 over configurations stored in the structured knowledge store 160.

A zero-step neighborhood comprises all admissible configurations across sections in which the domain element appears. A one-step neighborhood additionally includes configurations involving domain elements that co-occur with the specified domain element in valid configurations. Multi-step neighborhood expansion proceeds recursively, subject to defined limits and elimination of redundant traversal paths.

Neighborhood operations preserve domain constraint validity and hierarchical consistency. Retrieved information 140 may include structured representations of one or more neighborhoods constructed in this manner, thereby providing an entity-centric view of the admissible configuration space.

### Comparable Region Construction

In certain implementations, the system constructs comparable regions within a configuration space based on selected relational dimensions. A comparable region comprises a subset of admissible configurations that share common assignments or constraint conditions along one or more dimensions while varying along others.

Comparable regions may be defined with respect to anchor elements identified in the structured query representation. For a given anchor element, the system identifies admissible configurations in which the anchor participates and partitions those configurations according to selected dimensions. Each partition defines a comparable region representing a distinct class of interactions associated with the anchor.

In some implementations, relationships among comparable regions are organized according to a lattice or partial order structure in which regions may be compared, combined, or refined based on shared attributes or constraint conditions. Such organization enables structured comparison of interaction patterns and supports navigation among alternative relational contexts within the configuration space.

Comparable region construction facilitates identification of structurally similar or contrasting interaction configurations and enables systematic exploration of variation within admissible multi-entity interactions.

### Overlap and Comparison Operations

The structured relational model permits detection and analysis of overlap between configuration regions or neighborhoods. Overlap is defined as the set of shared admissible configurations between two structured units. Comparison operations may identify common configurations shared between two regions, configurations unique to one region, structural differences at specified refinement levels, or differences in metric attribution.

Such operations are performed over admissible multi-entity interaction configurations and preserve n-ary relational integrity rather than decomposing interactions into independent pairwise comparisons. Comparison results may be incorporated into retrieved information 140.

### Constraint-Based Validation and Conflict Isolation

Validation operations determine whether a configuration satisfies all applicable domain constraints within its section and across the hierarchical refinement structure. Filtering operations restrict configuration regions to configurations meeting additional logical or domain-specific conditions. Constraint propagation may be used to enforce local-to-global consistency across overlapping sections and refinement levels.

Where incompatible assignments are detected, conflict isolation procedures may segregate conflicting configurations into distinct structural regions governed by coherent constraint sets. Such segregation permits representation of alternative admissible structural regimes without collapsing them into inconsistent sections. Validation and conflict isolation may be executed by the information retriever 130 during evaluation of configuration regions derived from a query model 116.

### Metric Computation and Hierarchical Attribution

The structured relational model supports computation of hierarchical metrics over distributions of admissible configurations maintained within the structured knowledge store 160. Metrics may reflect structural novelty, interaction complexity, participation magnitude, rarity, or other properties derived from the configuration space.

Metric attribution assigns computed metric values to sections, configuration regions, neighborhoods, or domain elements based on participation in admissible configurations. Attribution may be governed by weighting rules that account for overlapping participation across sections and refinement levels. Normalization operations may be applied to ensure that metric contributions are not double-counted across overlapping configuration regions and that attributed metrics remain comparable across refinement levels. Metric values may be included in retrieved information 140.

### Memory and Recall Operations

Configuration regions, neighborhoods, or sections may be stored persistently within the structured knowledge store 160 or associated memory structures and later recalled. Recall operations restore the structural, sectional, and metric context of the stored region. Comparison operations may then be applied between stored and current configuration regions to detect structural changes, metric variation, or shifts in admissibility boundaries. Such operations enable structured reconstruction of prior exploration states within the admissible configuration space defined by the domain model 150.

### 4. Overall System Operation

FIG. 1 illustrates a system architecture that operationalizes the structured relational model defined by the domain model 150 and represented within the structured knowledge store 160. The system supports both maintenance of the structured relational model and runtime query processing. The present section focuses primarily on query processing operation. Structural learning and maintenance of the domain model and structured knowledge store are described separately.

In query processing mode, the system receives user input 112 and transforms it into a structured query representation expressed in terms of the domain model 150. The structured query representation defines one or more partially or fully specified multi-entity relational configurations corresponding to regions within the admissible configuration space defined by the domain model. The information retriever 130 evaluates these structured representations against admissible configurations maintained in the structured knowledge store 160 to identify compatible configuration regions. Retrieved information 140 is generated from such compatible configuration regions and returned to the user.

### Natural Language Interpretation and Structured Query Representation

Operation begins when user interface module 102 receives a user query. The query may be expressed in natural language, may reference previously returned structured results, or may combine natural language expressions with explicit structural constraints.

In some implementations, deriving the structured query representation further includes constructing a relational topology corresponding to the user input. The relational topology comprises a hypergraph structure in which nodes correspond to domain elements or relational roles and hyperedges correspond to unary, binary, or n-ary relational signatures defined by the domain model. Identified domain elements are assigned to relational roles within this topology, while one or more roles may remain unspecified, thereby defining a partially instantiated multi-entity relational configuration. The resulting structure constitutes a context signature that provides a structural address within the admissible configuration space. The context signature identifies one or more relational sections and associated constraint structures relevant to the user input and thereby bounds subsequent retrieval operations to corresponding regions of the structured relational model.

In certain implementations, the relational topology derived from the user input defines a localized region within a structured relational space induced by the domain model. The domain model, through its relational sections and hierarchical refinement structure, defines an ambient relational space in which admissible multi-entity configurations reside. The relational topology constructed from the user input selects a subregion of this space corresponding to the entities, relational roles, and constraints expressed or implied by the input.

This subregion may be interpreted as a neighborhood within the relational space centered on one or more anchor elements identified from the user input. The neighborhood is bounded by relational signatures, constraint predicates, and refinement relationships relevant to the query, and excludes portions of the configuration space that are structurally unrelated to the query context.

In this manner, the structured query representation operates not merely as a pattern to be matched, but as a geometric or topological specification of a region within the admissible configuration space. Subsequent retrieval operations are restricted to configurations and configuration regions within this selected region, thereby reducing evaluation complexity and ensuring structural relevance to the user input.

In certain implementations, the structured query representation further includes identification of one or more anchor elements. An anchor element corresponds to a domain element, relational role, or relational context that serves as a primary coordinate reference for exploration within the configuration space. Anchor elements may be identified based on prominence within the user input, statistical relevance within the domain model, or learned patterns of user interaction. The anchor elements define one or more local coordinate systems within the configuration space and guide subsequent neighborhood construction, selection of differentiating relational dimensions, and organization of retrieved information, including partitioning of admissible configurations into regions that differentiate entity participation patterns relative to the anchor elements.

In some embodiments, anchor elements define coordinate centers within the relational space, and the structured query representation defines coordinates relative to these centers through assignment of relational roles and constraint predicates. Neighborhood construction, dimension selection, and configuration-region evaluation are performed relative to these anchor-centered coordinate systems, enabling localized exploration of the configuration space.

Structural conversion module 104 processes the input to derive a structured query representation expressed in terms of the domain model 150. The structured query representation comprises a relational signature corresponding to a unary, binary, or n-ary section of the structured relational model; one or more assigned relational roles populated with identified domain elements; zero or more unspecified relational roles; and zero or more domain constraint predicates derived from the query.

Named entities in the query are identified and resolved to canonical domain elements maintained in the structured knowledge store 160. Relational intent is determined by identifying linguistic structures corresponding to participation, association, classification, comparison, restriction, or other relational patterns defined by the domain model 150. Role assignments are derived by mapping identified domain elements to relational roles defined by the relational signature. Domain constraint predicates, such as numerical thresholds, categorical filters, temporal conditions, or logical qualifiers, are extracted and formalized as predicates compatible with the domain constraints defined by the domain model.

Structural conversion may employ rule-based techniques, statistical models, transformer-based models, large language models, or combinations thereof. Candidate structured representations are validated against domain sets, relational signatures, and domain constraints defined within the domain model 150 to ensure structural consistency. The resulting structured query representation defines a partially or fully specified multi-entity relational configuration corresponding to a region within the admissible configuration space.

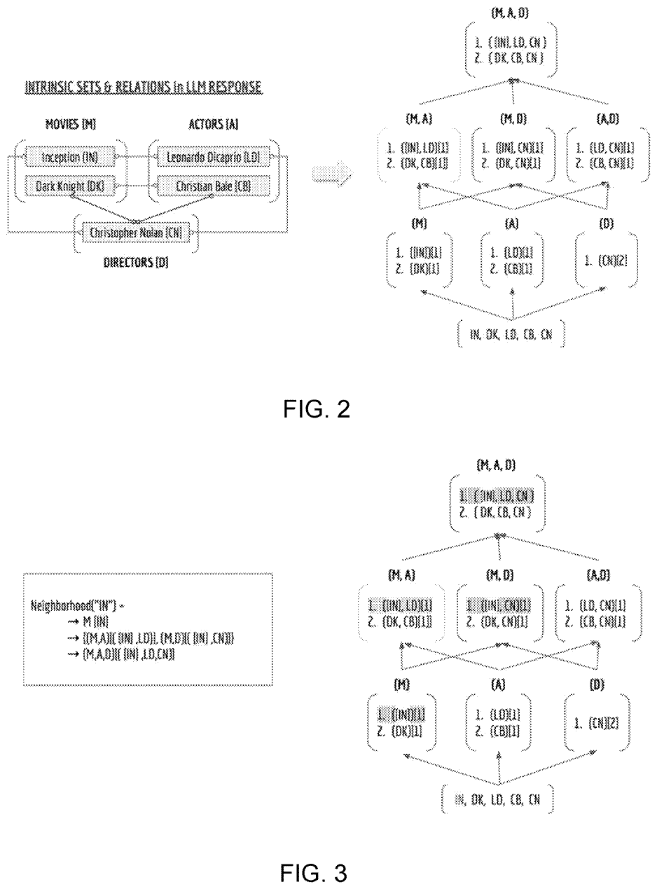

### Formation of Configuration Regions (FIG. 2)

FIG. 2 illustrates derivation of a configuration region from a structured query representation.

A structured query representation includes a relational signature, one or more assigned relational roles populated with domain elements, one or more unspecified relational roles, and one or more domain constraint predicates. The structured query representation is evaluated against a corresponding relational section of the structured relational model represented within the structured knowledge store 160.

Each relational section stores or references valid configurations representing admissible multi-entity interaction configurations under the relational signature and associated domain constraints defined by the domain model 150.

Configuration processing and compatibility engine 106 evaluates the structured query representation against the relational section by selecting a subset of valid configurations that satisfy the relational role assignments specified in the query, the domain constraint predicates derived from the query, the section-level domain constraints associated with the relational section, and hierarchical consistency requirements within the hierarchical refinement structure.

The resulting subset defines a configuration region comprising configurations compatible with the structured query representation. Where unspecified relational roles are present, the configuration region corresponds to all admissible completions of the partially specified multi-entity relational configuration defined by the structured query representation. In this manner, partially specified configurations act as operators defining regions within the admissible configuration space.

Each configuration region retains association with its originating relational section and maintains hierarchical context within the structured relational model.

### Hierarchical Refinement and Projection (FIG. 3)

FIG. 3 illustrates the hierarchical refinement structure among relational sections defined by the domain model 150.

A higher-order relational section corresponding to an n-ary relational signature may refine a lower-order relational section through the addition of relational roles or additional domain constraints. Valid higher-order configurations represent admissible multi-entity interaction configurations satisfying the relational signature and associated constraints.

Through a projection operator, each valid higher-order configuration induces a projected lower-order configuration in the corresponding lower-order section by eliminating one or more relational roles while preserving assignments to retained roles. A projected lower-order configuration is valid if and only if the originating higher-order configuration satisfies all domain constraints applicable to the retained roles. Projection therefore preserves admissibility within the configuration space.

Where configuration regions span overlapping relational sections sharing common domain elements, compatibility engine 106 enforces local-to-global consistency by ensuring that assignments to shared domain elements remain coherent across overlapping sections and across refinement levels.

When a structured query representation specifies a lower-order relational configuration, compatibility engine 106 may traverse upward within the hierarchical refinement structure to identify higher-order configurations consistent with the specified lower-order assignments. Conversely, when a higher-order configuration region is identified, projection operations may derive corresponding lower-order configuration regions consistent with the refinement structure. Such traversal supports drill-down and drill-up exploration while preserving domain constraint validity and hierarchical consistency.

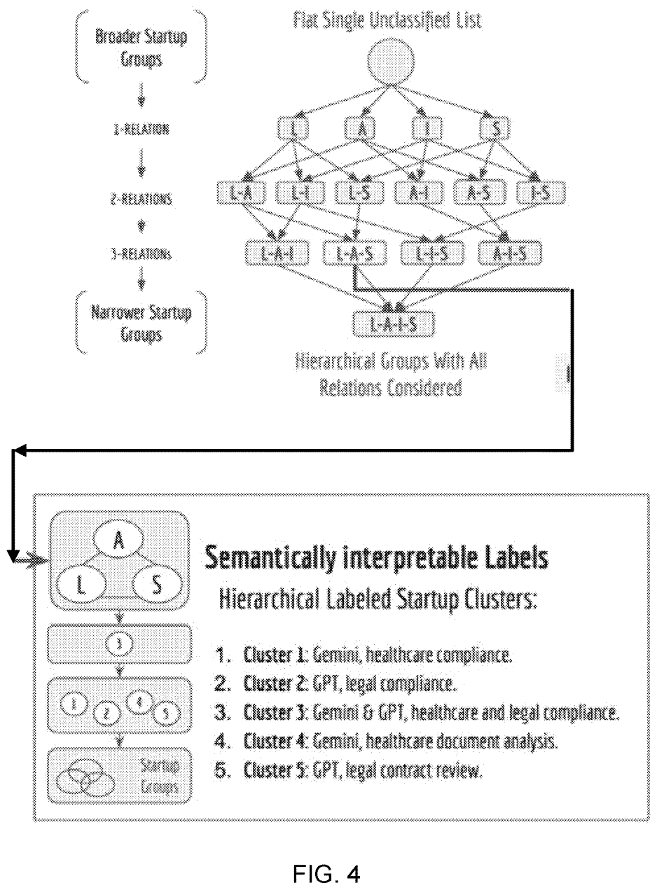

### Neighborhood Construction and Expansion (FIG. 4)

FIG. 4 illustrates neighborhood construction for a domain element within the structured relational model.

A zero-step neighborhood of a domain element comprises all valid configurations across all relational sections in which the domain element participates. These configurations may span unary, binary, and n-ary sections at multiple refinement levels. Neighborhood construction aggregates such configurations while preserving sectional organization and hierarchical context.

A one-step neighborhood expands the zero-step neighborhood by identifying co-participating domain elements that appear in valid configurations with the specified domain element. Configurations involving such co-participating elements are incorporated into the expanded neighborhood, subject to admissibility and domain constraint validation. Multi-step neighborhood expansion proceeds recursively, subject to a defined step limit and redundancy control.

At each stage of neighborhood expansion, only admissible configurations defined by the domain model 150 are included. Domain constraints and hierarchical consistency are preserved throughout expansion. The resulting neighborhood constitutes a structured configuration region organized across relational sections and refinement levels.

Neighborhood operations may be combined with restriction, intersection, projection, composition, and metric attribution operations to generate structured retrieved information 140 responsive to the query.

### Algebraic Operations and Iterative Refinement

Configuration regions derived from structured query representations may be combined, refined, or compared using algebraic operations including intersection, union, difference, restriction, projection, and composition. These operations are performed by compatibility engine 106 and the information retriever 130 over configuration regions represented within the structured knowledge store 160.

Each operation preserves admissibility within the configuration space and maintains consistency across overlapping relational sections and refinement levels. Restriction operations narrow configuration regions by applying additional domain constraint predicates. Projection operations derive lower-order regions from higher-order regions. Composition operations combine compatible partially specified regions by aligning shared relational roles and enforcing domain constraint consistency.

### Structured Response Generation

In certain implementations, retrieved configuration regions are organized into a structured response representation corresponding to a hierarchical arrangement of relational contexts. The structured response representation comprises a plurality of context units, each associated with a configuration region derived from the structured query representation.

The context units are organized according to a hierarchy that progresses from broader relational contexts to more specific configurations. The hierarchy may be derived from the hierarchical refinement structure of the domain model, from selected relational dimensions, or from anchor-based organization. In some implementations, the structured response representation is constructed by mapping the underlying configuration space, which may comprise overlapping relational sections, into a tree-like structure suitable for navigation while preserving underlying relational relationships.

Each context unit may include associated domain elements, admissible configurations, derived summaries, associated question types, and supporting evidence from the source knowledge store. The structured response representation thereby provides a navigable view of the configuration space corresponding to the user's query.

Because the structured response representation is derived from admissible configuration regions within the structured relational model, it preserves domain constraints, hierarchical consistency, and relational integrity. The structured response representation enables iterative exploration in which a user may navigate among contexts, refine constraints, and generate additional structured query representations that further restrict or expand the corresponding configuration regions.

After a configuration region has been identified, information retriever 130 retrieves information based on that configuration region and returns structured output to user interface module 102. Retrieved information 140 may include domain elements, configuration summaries, neighborhood structures, comparative analyses, or hierarchical metrics associated with the configuration region.

In subsequent interactions, a user may refine a prior result by adding additional relational role assignments or domain constraint predicates. Structural conversion module 104 generates a new structured query representation referencing a prior configuration region and specifying additional restrictions. Compatibility engine 106 applies restriction, intersection, projection, or composition operations directly to the referenced configuration region to derive a refined configuration region without recomputing the entire configuration space.

Through the operations illustrated in FIGS. 2-4, the system processes natural language queries by transforming them into structured query representations and operating directly over admissible multi-entity interaction configurations within the structured relational model. At each stage—formation of configuration regions, hierarchical traversal, neighborhood construction, algebraic manipulation, and iterative refinement—the system preserves domain constraint validity, sectional organization, and hierarchical consistency within the admissible configuration space.

In certain implementations, generation of the structured response representation follows an anchor-driven transformation pipeline that links query interpretation, configuration-space analysis, and presentation. One or more anchor elements identified in the structured query representation define entry points into the configuration space and corresponding neighborhoods of admissible configurations. Based on these anchors, the system selects a set of differentiating relational dimensions that partition the admissible configurations into structurally distinct regions characterized by differing patterns of entity participation across relational roles relative to the anchor elements. A differentiating cover is then constructed over the anchor-centered configuration space, wherein each region corresponds to a distinct relational context defined by combinations of the selected dimensions and associated constraints. The structured response representation is generated by mapping the regions of the differentiating cover into a hierarchical, navigable arrangement of context units, such that higher-level contexts correspond to broader aggregations of configurations and lower-level contexts correspond to progressively refined subsets. In this manner, the structured response provides a coherent transformation from anchor-centered query intent to a finite, navigable representation of the admissible configuration space, enabling systematic exploration, comparison, and refinement by the user.

### 5. Learning

Learning constructs, updates, and maintains the structured relational model defined by the domain model 150 and represented within the structured knowledge store 160 of FIG. 1. The learning processes are primarily executed by structure learner 170 and associated processing components. Through learning, domain elements, relations, relational sections, hierarchical refinement links, domain constraints, admissible configurations, neighborhoods, and associated metrics are established and maintained in the arrangement described above in the section on Arrangement of Information. In certain implementations, the learning process further induces reusable relational structures that generalize across multiple queries and query contexts. Such structures include relational signatures, constraint patterns, admissible configuration templates, and refinement relationships that are not limited to a single query instance but instead define transferable components of the configuration space. These reusable structures enable extension of the system's reachable reasoning space across queries by permitting newly received queries to be evaluated against previously learned structural patterns. The resulting structured relational model defines the admissible configuration space over which the operations described in the section on Operations on Information are performed during query processing. Such reusable relational structures may be persistently stored within the structured relational model and updated across successive queries, such that relational patterns, admissible configuration templates, and constraint relationships identified in earlier queries remain available for reuse and extension in later queries. In this manner, the structured relational model operates as a persistent, incrementally updated memory that aggregates relational structures derived from both source data and prior query interactions, which can be used across domains.

Learning may operate over heterogeneous source data contained in source knowledge store 180, including unstructured textual corpora, structured databases, knowledge graphs, semi-structured documents, and other machine-readable sources. Learning may be executed in batch mode, streaming mode, or incrementally, such that updates to the configuration space are incorporated while preserving hierarchical consistency and previously established admissibility constraints.

### Identification of Domain Elements and Domain Sets

Structure learner 170 ingests source data and identifies candidate domain elements to populate the domain sets defined by domain model 150. From structured sources, domain elements may be imported from existing identifiers or primary keys. From textual or semi-structured sources, domain elements may be identified through entity recognition, coreference resolution, canonicalization, and entity linking.

Canonicalization resolves aliases, merges duplicates, assigns stable identifiers, and associates metadata relevant to relational role assignment and domain constraint evaluation. Each domain element is inserted into one or more domain sets defined in the domain model 150. Where a candidate entity cannot be resolved to an existing identifier within structured knowledge store 160, a new domain element may be created and inserted, subject to integrity checks to avoid redundancy or inconsistent typing.

The resulting domain elements correspond to the atomic referents described in the Arrangement of Information section and form the basis for constructing relations, sections, and configurations.

### Coupled Relation-Question-Source (R-Q-S) Structures

In certain implementations, learning and operation of the structured relational model are governed by a coupled triad of relational, interrogative, and evidentiary structures, referred to as relation-question-source (R-Q-S) structures. These structures are not maintained independently, but are jointly constructed, updated, and enforced throughout learning and query processing.

The relational structure (R) comprises relational signatures, relational sections, and admissible multi-entity configurations defined over domain elements, as described above. The question structure (Q) comprises classes of queries, interrogative forms, or information requests that are expressible with respect to the relational structure. The source structure (S) comprises evidentiary materials, including documents, records, or other data, from which relational configurations are derived and against which configurations may be validated.

Learning establishes bidirectional correspondences among R, Q, and S such that: (i) relational configurations in R are supported by one or more source elements in S; (ii) question types in Q map to relational signatures and configuration regions in R capable of satisfying those questions; and (iii) source elements in S provide evidence for answers corresponding to question types in Q. These correspondences define a coupled structure in which relations, questions, and sources are jointly aligned.

In operation, the R-Q-S structures actively constrain and guide both learning and retrieval. When candidate configurations are generated or selected, the system evaluates whether the configurations are (i) supported by corresponding source evidence in S, (ii) responsive to one or more interrogative forms in Q, and (iii) consistent with the relational constraints defined in R. Configurations that fail to satisfy one or more of these conditions may be rejected, down-weighted, or isolated into separate structural regions.

In some implementations, consistency across the R-Q-S structures is enforced through multi-path compatibility evaluation. For a given candidate configuration, the system may evaluate multiple relational projections, question mappings, and source alignments, and determine whether the resulting assignments are mutually consistent. A configuration is considered valid if corresponding mappings across R, Q, and S agree under such multi-path evaluation. Disagreement among mappings indicates structural inconsistency and may result in exclusion or segregation of the configuration. This consistency enforcement reduces propagation of unsupported or spurious associations and preserves structural integrity of the configuration space.

The R-Q-S structures further participate in prompt-conditioned refinement. In response to a structured query representation, the system identifies relevant portions of the relational structure R, corresponding interrogative forms in Q, and supporting source regions in S. These identified portions define a constrained subspace within which admissible configurations are evaluated and expanded. In this manner, R-Q-S structures guide selection of relevant relational dimensions, support construction of differentiating covers, and ensure that retrieved configuration regions remain grounded in both query intent and supporting evidence.

In certain implementations, enforcement of consistency across the R-Q-S structures includes verification of compatibility across overlapping relational contexts using a commutativity condition over corresponding mappings. For a candidate configuration supported by multiple relational, interrogative, and evidentiary paths, the system evaluates whether mappings derived from these distinct paths agree when projected onto shared relational roles or domain elements.

In some embodiments, the mappings are represented in a form that permits evaluation of compositional consistency, such that compositions of mappings along alternative paths are required to produce equivalent results. A candidate configuration is admitted into the structured relational model only if such multi-path consistency conditions are satisfied. Configurations that fail to satisfy these conditions are rejected or partitioned into separate structural regions.

This consistency enforcement reduces propagation of incompatible or unsupported relational assignments and constrains admissible configurations to those that are jointly supported across relational structure, query structure, and source evidence.

Accordingly, the coupled R-Q-S structures provide a unifying framework that integrates relational modeling, query interpretation, and evidentiary grounding. By jointly constraining admissibility, guiding refinement, and enforcing consistency across multiple structural views, the R-Q-S structures enable reliable construction and exploration of configuration regions within the structured relational model.

### Identification of Relational Signatures and Roles

Learning further identifies or refines relational signatures and associated relational roles defined by domain model 150. A relational signature specifies arity, participating domain sets, and role differentiation, and corresponds directly to the sections described in the Arrangement of Information section.

Relational signatures may be derived from structured schemas, mapped from relational databases, extracted from knowledge graphs, or inferred by detecting recurring multi-entity interaction patterns. Role identification may be performed by mapping structured field names to canonical roles, extracting semantic role structures from text, or applying learned role-labeling models.

In heterogeneous environments, relational signatures may be normalized across sources. Normalization aligns equivalent roles, merges structurally equivalent signatures, resolves naming discrepancies, and harmonizes differences in granularity. The resulting relational signatures define the structural axes of the configuration space and determine the organization of relational sections in structured knowledge store 160.

### Identification and Formalization of Domain Constraints

Learning identifies and formalizes domain constraints governing admissible assignments of domain elements to relational roles, as described previously in the Domain Constraints subsection of the Arrangement of Information section.

Domain constraints may include type restrictions derived from domain sets, role-specific participation rules, cardinality limits, compatibility requirements among roles, equality or inequality conditions, temporal ordering constraints, and logical dependencies. Some constraints may be explicitly defined in structured schemas or ontologies. Others may be inferred from statistical regularities, co-occurrence behavior, exclusivity patterns, or systematic absence of certain assignments.

Inferred constraints are formalized as predicates associated with relations and sections in domain model 150. These constraints are applied during admissibility evaluation in learning and later reused by compatibility engine 106 during query processing operations described in the Operations on Information section.

### Construction of Candidate Configurations

Using identified domain elements and relational signatures, structure learner 170 constructs candidate configurations corresponding to multi-entity relational assignments.

From structured sources, candidate configurations are generated by mapping records to tuples of canonical domain element identifiers aligned with relational roles defined by a relational signature. From textual sources, candidate configurations are derived by extracting entities and role bindings within text and assembling them into tuples under one or more relational signatures.

Candidate configurations may be fully specified or partially specified. Partial configurations may include missing or uncertain roles and may be stored with confidence or provenance metadata within structured knowledge store 160. Such partial assignments correspond to partially specified configurations described in the Operations on Information section and may later define configuration regions during query processing.

### Validity Determination and Admissibility Evaluation

Structure learner 170 evaluates each candidate configuration for validity within its corresponding relational section.

Validity determination applies domain constraints associated with the relational signature and section, including type compatibility, role participation rules, cardinality constraints, and compatibility predicates. Hierarchical validity is enforced by verifying that projections of higher-order candidate configurations into lower-order sections are also valid, consistent with the hierarchical refinement structure described earlier.

Candidate configurations that satisfy all applicable constraints are inserted into admissible sections within structured knowledge store 160. Configurations that violate constraints may be excluded, stored separately for diagnostic analysis, or used to refine inferred constraints. Through this process, learning defines and maintains the admissible subset of assignments that constitute the configuration space.

### Statistical Support and Admissibility Boundaries

Learning may further evaluate statistical support for candidate configurations and interaction patterns. Statistical measures may include frequency counts, co-occurrence metrics, likelihood measures, extraction confidence scores, or provenance-based weighting.

Configurations lacking sufficient support may be excluded from admissible sections or assigned reduced confidence. Conversely, rare but well-supported configurations may be retained. Support modeling influences admissibility boundaries and may inform refinement of domain constraints.

Learning may also infer negative constraints defining structurally impermissible regions of the configuration space. Where combinations of domain elements and roles consistently fail to occur in sufficiently supported regions, incompatibility or exclusivity rules may be inferred. Such negative constraints are incorporated into section-level domain constraints and subsequently enforced during compatibility determination in query processing.

In some implementations, statistical support evaluation further identifies recurring multi-entity interaction patterns that are abstracted into reusable relational structures. Such structures may be represented independently of specific domain element assignments and subsequently instantiated across multiple query contexts, thereby enabling transfer of learned admissibility patterns beyond the original observations.

### Construction of Relational Sections and Hierarchical Refinement

Valid configurations are organized into relational sections corresponding to their relational signatures and associated constraints, as described in the Arrangement of Information section. Each section is represented within structured knowledge store 160 and may maintain indices keyed by domain element participation, relational role assignments, constraint predicates, refinement level, or neighborhood membership.

Structure learner 170 establishes and maintains the hierarchical refinement structure among sections. Projection relationships among relational signatures define structural links between higher-order and lower-order sections. Refinement links are created or updated where one section imposes additional roles or constraints relative to another. Refinement preserves projection consistency such that valid configurations in refined sections induce valid configurations in the sections they refine.

These refinement links define the structural adjacency relationships traversed by compatibility engine 106 during projection, drill-down, and drill-up operations described in the Operations on Information section.

### Prompt-Conditioned Structural Refinement and Dimension Selection

In certain implementations, learning further includes prompt-conditioned refinement of the structured relational model during query processing. While the structured relational model defines a global configuration space learned from domain-associated data, a received user query may induce selection and refinement of a subset of that configuration space.

In response to a structured query representation, the system identifies a subset of relational sections, relational roles, and domain constraints that are relevant to the context signature and anchor elements derived from the query. The system further evaluates candidate relational dimensions corresponding to variations among admissible configurations within the identified sections. Such dimensions may include relational roles, attributes, or constraint parameters that distinguish among configurations.

A selection process identifies a subset of dimensions that are maximally informative or differentiating with respect to the structured query representation. Differentiation may be determined based on statistical variation, information gain, distributional diversity, or other learned criteria. The selected dimensions define axes along which admissible configurations are partitioned into distinguishable regions.

This prompt-conditioned refinement enables the system to focus retrieval and exploration on structurally relevant and informative aspects of the configuration space without recomputing the entire model. The refined set of sections, dimensions, and associated configurations defines a query-specific subspace of the structured relational model.

In some implementations, the prompt-conditioned refinement further includes extending the structured relational model by incorporating newly identified configuration regions or constraint relationships derived during evaluation of the query, such that the configuration space evolves across successive queries.

In some implementations, configuration regions, relational dimensions, or constraint relationships identified during prompt-conditioned refinement are incorporated into the structured relational model for subsequent reuse in a system memory, which grows over time and may be used across domains. Such incorporation enables the system to accumulate query-derived structural knowledge over time, thereby expanding the set of representable (e.g., higher order constraints) relational configurations and improving efficiency and expressiveness in subsequent query processing.

### Overlap Detection and Consistency Enforcement

Learning may detect overlap among relational sections where sections share domain element subsets or projected substructures. Overlap alignment reconciles shared domain elements and propagates constraint implications across overlapping sections.

Where inconsistencies are detected, constraint propagation procedures may isolate conflicts and segregate incompatible configurations into distinct structural regions governed by coherent constraint sets. This preserves local-to-global consistency across sections and across the hierarchical refinement structure, ensuring that the configuration space remains coherent for subsequent operations.

### Structural Optimization and Maintenance

Learning may include structural optimization procedures within structured knowledge store 160. Such procedures may include pruning low-support or redundant configurations, merging equivalent sections, splitting sections where structurally distinct interaction types are conflated, and re-indexing sections after significant updates.

Optimization preserves hierarchical validity by ensuring that removal or restructuring of configurations at higher-order levels does not introduce inconsistencies in lower-order projections.

### Neighborhood Maintenance and Metric Attribution

As admissible configurations are inserted, updated, or removed, neighborhoods of participating domain elements are updated in accordance with the Neighborhoods subsection of the Arrangement of Information section. Neighborhood structures may be incrementally maintained or cached to support efficient neighborhood construction during query processing.

Learning may also compute hierarchical metrics over distributions of admissible configurations. Metrics may reflect interaction complexity, novelty, participation magnitude, rarity, or other structural properties of the configuration space. Metric attribution assigns values to sections, configuration regions, neighborhoods, or domain elements and is maintained in a manner consistent with the normalization and attribution principles described in the Operations on Information section.

### Incremental Updates and Versioning

Learning may operate incrementally as new data is ingested from source knowledge store 180. New domain elements, relational signatures, configurations, support measures, and domain constraints may be introduced. Affected sections are updated, refinement links adjusted, overlap alignments reconciled, and implications propagated throughout the hierarchical refinement structure.

In some implementations, versioned snapshots of the structured relational model are maintained within structured knowledge store 160. Versioning enables reconstruction of prior configuration regions, comparison of structural evolution over time, and preservation of historical admissibility boundaries for use in later query evaluation.

Through the learning processes described above, structure learner 170 constructs and maintains the structured relational model implemented in structured knowledge store 160. This model organizes admissible multi-entity interaction configurations into relational sections spanning unary, binary, and n-ary signatures, arranged within a hierarchical refinement structure, and governed by explicit and learned domain constraints. The resulting admissible configuration space provides the structural foundation upon which the query processing operations of FIGS. 1-4 operate.

### 6. Illustrative Use Cases

The structured relational model, configuration-space representation, and associated operations described above may be applied to domains in which heterogeneous signals, contextual qualifiers, and situational segments must be integrated into a coherent multi-entity interaction structure governed by domain constraints. One illustrative example is clinical knowledge interaction and physiological signal modeling. This example is provided to demonstrate how the domain model 150, structured knowledge store 160, and the query processing operations of FIGS. 1-4 operate in a concrete domain.

In a clinical knowledge domain, domain elements, as defined in the Arrangement of Information section, may include medical conditions, medications, dosages, patient attributes, physiological signal features, anatomical regions, time segments, and patient states. These elements populate domain sets defined by domain model 150 and are stored in structured knowledge store 160 following learning by structure learner 170.

Relational signatures define multi-entity interaction configurations over these domain sets. Examples include relational signatures such as (Condition, Medication, Dosage), (SignalFeature, AnatomicalRegion, TimeWindow), (Symptom, Treatment, PatientContext), or higher-order signatures such as (SignalFeature, Region, TimeSegment, PatientState). Each relational signature corresponds to a relational section within the structured relational model, and admissible assignments under each signature define a corresponding region of the configuration space.

Domain constraints encode admissibility rules, such as dosage limits, contraindications, compatibility conditions between medications and conditions, physiological plausibility constraints, temporal ordering constraints, or structural dependencies among signal features and anatomical regions. These constraints are stored as predicates associated with relations and sections in domain model 150 and are enforced both during learning and during compatibility determination by compatibility engine 106 in query processing mode.

Learning in such a domain may involve structure learner 170 extracting candidate configurations from clinical literature, structured medical records, device telemetry streams, or physiological signal data. For example, neural sensing data collected from multiple anatomical regions over time may be processed to derive signal features associated with sympathetic activity. Extracted domain elements and role bindings are assembled into candidate configurations under relational signatures such as (SignalFeature, Region, TimeSegment, PatientState). Validity determination and admissibility evaluation insert supported and constraint-consistent configurations into the appropriate relational sections of structured knowledge store 160, thereby defining the admissible configuration space for the clinical domain.

The structured relational model organizes these configurations into relational sections arranged within the hierarchical refinement structure described previously. Broader clinical contexts, such as patient-level sympathetic state, may correspond to higher-order sections that refine into more specific contexts, such as region-specific signal behavior under defined temporal conditions. Projection operations, as described in the Operations on Information section and illustrated in FIG. 3, permit mapping higher-order interaction configurations to lower-order region-specific or time-specific views while preserving admissibility constraints.

In query processing mode, a clinician or researcher may submit a natural language query, such as a query regarding medication response under particular physiological conditions. Structural conversion module 104 derives a structured query representation corresponding to one or more partially specified multi-entity relational configurations. Compatibility engine 106 evaluates the structured query representation against the relevant relational sections within structured knowledge store 160 to identify compatible configuration regions. The resulting configuration region corresponds to admissible clinical interaction configurations satisfying the relational role assignments and domain constraint predicates specified in the query.

Neighborhood operations, as described in the Neighborhoods subsection and illustrated in FIG. 4, may construct structured views centered on a given patient, signal feature, medication, or clinical condition. A zero-step neighborhood may include all admissible configurations in which the selected domain element participates. Multi-step neighborhood expansion may aggregate configurations involving co-participating elements across refinement levels, subject to admissibility and hierarchical consistency. The information retriever 130 may present such neighborhoods as structured retrieved information 140.

Algebraic operations over configuration regions enable structured composition and comparison of interaction patterns. For example, a configuration region representing signal-feature behavior in one anatomical region may be intersected with a configuration region representing a specific medication regimen to identify admissible joint interaction configurations. Projection operations may derive lower-order summaries of higher-order clinical interaction patterns. Composition operations may combine signal-feature regions with medication-response regions to derive higher-order admissible clinical interaction spaces, consistent with the composition operations described in the Operations on Information section.

Because the admissible configuration space is explicitly defined by domain constraints and learned structural regularities, the system may further perform configuration gap detection. A configuration that satisfies all structural and domain constraints defined by domain model 150, yet is not present among the learned admissible configurations in structured knowledge store 160, represents a structurally admissible but unobserved configuration. In a clinical context, such a configuration may correspond to a plausible but undocumented drug-condition interaction, region-to-region signal correlation, or temporal state transition. Identification of such structurally admissible but unobserved regions of the configuration space may guide hypothesis generation, experimental design, or clinical investigation.

In some embodiments, the structured relational model may be presented through a hierarchical, navigable interface in which relational sections correspond to structured contexts and configuration regions correspond to admissible interaction cells within those contexts. Such an interface may expose drill-down, drill-up, projection, restriction, and neighborhood operations described previously, allowing deterministic navigation of the configuration space while preserving domain constraints and local-to-global consistency across overlapping relational regions.

Although the foregoing example is described in a clinical and physiological signal context, the same structured relational model, configuration-space representation, and operations are applicable to other domains involving constrained multi-entity interaction configurations. Examples include scientific knowledge modeling, financial interaction modeling, engineering system design, and any domain in which admissible compositions of interacting elements are governed by domain constraints and hierarchical refinement structure. In each such domain, domain model 150 defines the structural rules of admissibility, structured knowledge store 160 maintains valid configurations organized into relational sections, and the query processing operations of FIGS. 1-4 operate over the resulting admissible configuration space.

### 7. Implementation in Software and Hardware

The methods and operations described herein may be implemented in software, hardware, firmware, or any combination thereof. In some embodiments, the disclosed techniques are implemented as a computer-implemented method executed by one or more processors. In some embodiments, the disclosed techniques are implemented as a system comprising one or more processors and one or more memories storing instructions that, when executed by the one or more processors, cause performance of the operations described herein. In some embodiments, the disclosed techniques are implemented as a non-transitory computer-readable storage medium storing instructions that, when executed by one or more processors, cause performance of the operations described herein.

In some implementations, the instructions cause the one or more processors to perform operations including learning a structured relational model defining admissible multi-entity interaction configurations subject to domain constraints; receiving a natural language query; deriving, from the natural language query, a structured query representation comprising at least one fully or partially specified multi-entity relational configuration; identifying one or more configuration regions compatible with the structured query representation; and retrieving information based on the one or more identified configuration regions.

The one or more memories may comprise one or more non-transitory computer-readable storage media. Non-transitory computer-readable storage media include tangible storage media capable of storing instructions, including, by way of example and not limitation, semiconductor memory devices, flash memory, magnetic storage media, optical storage media, solid-state storage devices, or other physical storage media.

In some implementations, the structured relational model, including relational sections, configurations, configuration regions, and the hierarchical refinement structure, is stored in one or more data stores and accessed by the one or more processors during learning and query processing. Such data stores may be implemented using database systems, in-memory data structures, distributed storage systems, or combinations thereof. The operations for identifying compatible configuration regions, enforcing consistency across overlapping configurations, performing algebraic operations over configuration regions, constructing neighborhoods, and generating structured responses may be implemented as one or more software modules executed by the one or more processors, or as specialized hardware, or as combinations thereof. The natural language processing used to derive the structured query representation may be implemented using rule-based techniques, statistical models, transformer-based models, large language models, or combinations thereof.

In some implementations, the structured knowledge store comprises section-indexed data structures in which each relational section is associated with (i) one or more role-keyed indices mapping a domain element identifier in a relational role to identifiers of admissible configurations containing the domain element in that role, (ii) one or more constraint indices mapping normalized constraint predicates to subsets of admissible configurations satisfying the predicates, and (iii) projection link structures that map higher-order configuration identifiers to lower-order projection identifiers to support refinement-consistent traversal. In operation, identifying a configuration region compatible with a structured query representation includes accessing the role-keyed indices for assigned roles to obtain candidate configuration identifiers, intersecting candidate sets with constraint-index-derived candidates for extracted predicates, and validating remaining candidates against section-level constraints and projection-consistency checks using the projection link structures.

In some implementations, interactive refinement is performed by applying region-to-region transformations over stored configuration-region identifiers rather than re-executing full query evaluation from source data. For example, a restriction operation narrows a prior region by applying additional constraint predicates using constraint indices, and a projection operation transforms a higher-order region into one or more lower-order regions using projection link structures, thereby reducing processor cycles and memory bandwidth relative to recomputing candidate configurations by rescanning the structured knowledge store.

Accordingly, the present disclosure encompasses computer-implemented methods, systems, and non-transitory computer-readable storage media corresponding to the operations described herein.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A computer-implemented method for information retrieval, comprising:
learning, from data associated with a domain, a structured relational model defining admissible multi-entity interaction configurations subject to domain constraints;
receiving a natural language query;
deriving, from the natural language query, a structured query representation comprising at least one fully or partially specified multi-entity relational configuration, the structured query representation including a relational topology defining a context signature within the structured relational model;
identifying, within the learned structured relational model, one or more configuration regions compatible with the structured query representation based on the context signature; and
retrieving information from an information store based on the identified configuration regions, including constructing a differentiating cover comprising a finite set of configuration regions and generating a structured response representation based on the differentiating cover.

2. The method of claim 1, wherein the differentiating cover comprises a plurality of configuration regions, each configuration region corresponding to a distinct relational context, the plurality of configuration regions collectively covering a query-specific portion of the structured relational model.

3. The method of claim 2, wherein the structured relational model comprises a plurality of relational sections representing unary, binary, and higher-order n-ary interaction configurations.

4. The method of claim 3, wherein the plurality of relational sections are organized according to a hierarchical refinement structure in which a first relational section refines a second relational section by imposing additional relational or constraint structure.

5. The method of claim 4, wherein the hierarchical refinement structure defines overlapping relational sections that share common entity subsets and constraint conditions.

6. The method of claim 1, wherein learning the structured relational model comprises learning, from data associated with the domain, admissible multi-entity interaction configurations and reusable relational structures applicable across multiple queries, subject to domain constraints.

7. The method of claim 6, wherein learning comprises determining statistically significant multi-entity interaction patterns and excluding configurations that violate constraint conditions.

8. The method of claim 1, wherein the domain constraints include role-specific participation rules governing permissible combinations of entities within an n-ary configuration.

9. The method of claim 1, wherein identifying compatible configuration regions comprises enforcing local-to-global consistency across overlapping multi-entity configurations.

10. The method of claim 1, further comprising performing an algebraic operation directly over two or more configuration regions as structured information units within the structured relational model.

11. The method of claim 10, wherein the algebraic operation comprises at least one of composition, projection, restriction, union, intersection, or difference of configuration regions.

12. The method of claim 11, wherein projection comprises deriving a lower-order configuration region from a higher-order multi-entity configuration while preserving admissibility constraints.

13. The method of claim 10, wherein composition comprises combining two partially specified multi-entity configurations to generate a consistent combined configuration region.

14. The method of claim 1, wherein the structured query representation comprises a partially specified multi-entity relational configuration including at least one unspecified relational role.

15. The method of claim 14, wherein identifying compatible configuration regions comprises expanding the partially specified relational configuration into admissible completed configurations within the structured relational model.

16. The method of claim 1, further comprising computing a hierarchical metric over the structured relational model and attributing the metric to configuration regions or entities.

17. The method of claim 16, wherein the hierarchical metric comprises at least one of novelty, complexity, or structural magnitude determined based on configuration distribution across refinement levels.

18. The method of claim 1, wherein the structured relational model defines, for an entity, a neighborhood comprising all admissible multi-entity configurations including the entity across refinement levels.

19. The method of claim 18, wherein retrieving information comprises retrieving information associated with the neighborhood of an entity derived from the structured query representation.

20. The method of claim 1, wherein deriving the structured query representation further comprises identifying one or more anchor elements, each anchor element defining a reference point for selecting configuration regions within the structured relational model.

21. The method of claim 1, wherein identifying the configuration regions comprises selecting a set of differentiating relational dimensions based on the structured query representation and partitioning admissible configurations according to the selected dimensions.

22. The method of claim 1, wherein constructing the differentiating cover comprises selecting configuration regions that jointly cover a query-specific portion of the structured relational model while minimizing redundancy among the configuration regions.

23. The method of claim 1, wherein generating the structured response representation comprises organizing the configuration regions of the differentiating cover into a hierarchical arrangement of relational contexts configured for user navigation.

24. The method of claim 1, wherein identifying the configuration regions further comprises evaluating candidate configurations based on (i) consistency with relational constraints, (ii) responsiveness to one or more query types, and (iii) support from source data.

25. The method of claim 1, wherein identifying the configuration regions comprises excluding candidate configurations that fail a multi-path consistency evaluation across relational projections.

26. A system for information retrieval, comprising:
one or more processors; and
one or more memories storing instructions that, when executed by the one or more processors, cause the one or more processors to:
learn, from data associated with a domain, a structured relational model defining admissible multi-entity interaction configurations subject to domain constraints;
receive a natural language query;
derive, from the natural language query, a structured query representation comprising at least one fully or partially specified multi-entity relational configuration;
identify, within the learned structured relational model, configuration regions compatible with the structured query representation; and
retrieve information from an information store based on the identified configuration regions.

27. A non-transitory computer-readable storage medium storing instructions that, when executed by one or more processors, cause the one or more processors to:
learn, from data associated with a domain, a structured relational model defining admissible multi-entity interaction configurations subject to domain constraints;
receive a natural language query;
derive, from the natural language query, a structured query representation comprising at least one fully or partially specified multi-entity relational configuration;
identify, within the learned structured relational model, configuration regions compatible with the structured query representation; and
retrieve information from an information store based on the identified configuration regions.
